(19) United States
(12) Patent Application Publication
(10) Pub. No.: US 2011/0239146 A1
(43) Pub. Date: Sep. 29, 2011

(54) AUTOMATIC EVENT GENERATION

(76) Inventors: Lala Dutta, Cupertino, CA (US); Scott Joseph Adler, Saratoga, CA (US)

(21) Appl. No.: 12/730,055

(22) Filed: Mar. 23, 2010

(51) Int. Cl. G06F 3/048

(52) U.S. Cl. 715/768; 715/780; 715/769; 715/764

(57) ABSTRACT

A text input is received in a calendar context. The text input is processed with a context-neutral extraction process to generate a first set of elements and with a calendar-specific extraction process to generate a second set of elements. A calendar event is created from the first set of elements and the second set of elements and displayed on a display device without confirming the elements of the calendar event with a user.

### FIELD OF THE INVENTION

Embodiments of the invention are generally directed toward generating calendar events in a calendar application, and more specifically toward automatically generating calendar events from a text input.

### BACKGROUND

Technologies for searching interesting patterns in a text input presented by a computer to a user are well-known. U.S. Patent Application No. 2008/0243841, assigned to the same entity as the instant application, is one example of a document describing such a technology.

Manual input of a calendar event, for example, by keyboard and mouse, presents a user with a dialog box that has various distinct fields, such as location, subject, date, time, etc. The user needs to navigate each of these fields to provide, according to the type of interface for that field, information describing the calendar event.

### SUMMARY

In one embodiment, a text input is received in a calendar context. The text input is processed with a context-neutral extraction process to generate a first set of elements and with a calendar-specific extraction process to generate a second set of elements. A calendar event is created from the first set of elements and the second set of elements and the event is displayed on a display device without confirming the elements of the calendar event with a user.

### BRIEF DESCRIPTION OF THE DRAWINGS

The present invention is illustrated by way of example and not limitation in the figures of the accompanying drawings in which like references indicate similar elements.

FIGS. 1A and 1B are diagrams illustrating an embodiment of an automatic event generation interface;

FIG. 2 is a flow chart illustrating a method of automatic event generation according to an embodiment of the invention;

FIG. 3 is a flow chart illustrating event data conflict resolution according to an embodiment of the invention;

FIG. 4 is a flow chart illustrating automatic generation of calendar events from selected text according to an embodiment of the invention;

FIG. 5 is a flow chart illustrating extraction of data from text input according to an embodiment of the invention;

FIG. 6 is diagram illustrating another embodiment of an automatic event generation interface;

FIG. 7 is a diagram illustrating still another embodiment of an automatic event generation interface;

FIG. 8 is a diagram of a data processing system that may be used with embodiments of the invention; and

FIG. 9 is a diagram of a device that may be used with embodiments of the invention.

### DETAILED DESCRIPTION

Various embodiments and aspects of the inventions will be described with reference to details discussed below, and the accompanying drawings will illustrate the various embodiments. The following description and drawings are illustrative of the invention and are not to be construed as limiting the invention. Numerous specific details are described to provide a thorough understanding of various embodiments of the present invention. However, in certain instances, well-known or conventional details are not described in order to provide a concise discussion of embodiments of the present inventions.

Reference in the specification to one embodiment or an embodiment means that a particular feature, structure or characteristic described in connection with the embodiment is included in at least one embodiment of the invention. The appearance of the phrase “in one embodiment” in various places in the specification do not necessarily refer to the same embodiment. The term “click” may refer to an input from a pointing device such as a mouse or a trackball. The term “click” may also refer to one or more user inputs on a touch screen or touch pad, including multiple simultaneous touches on the touch screen and various gestures on the touch screen. The term “click” may refer to a modified user input including input from multiple input devices, such as a touch screen, a pointing device, a keyboard, a microphone, etc. The term “keyboard” may refer to a physical keyboard with mechanical and/or electrical keys, or a portion of a touch screen or touch pad permanently or temporarily assigned for use as keystroke acquiring region. The term “drag” may refer to a combination of holding down a button on a pointing device and moving the pointing device. The term “drag” may also refer to holding one or more fingers down on a touch-sensitive surface and dragging the one or more fingers across the service. The term “drag” may refer to a combination of sustained touch inputs combined with input from another input device, including, but not limited to, one or more of the following: an accelerometer, a light sensor, and a button.

Calendar applications are used to schedule and manage events occurring over time. For example, a user may use a calendar application to keep track of upcoming meetings at work. The user may use another calendar to keep track of social appointments. In order to use the calendar application to manage these various calendar events, the events are input into the calendar through various means. The user may manually input the events, or the user may receive an email attachment that represents an event. The event may also be described in plain text in an email, and data detection techniques may be used to extract details of the event from the email.

Manually inputting a calendar event generally utilizes a dialog box which includes different fields, such as date, duration, subject, location, invitees, start time, the calendar to which the event belongs (e.g., work, social, etc.), and other elements. Each of these fields may use a different type of interface for receiving user input. For example, the subject of the event may be a text field, while the calendar selection may be a drop down menu, while start time may be a specialized interface separated into hour, minute, day, month, etc. To input a new calendar event the user types, clicks, and otherwise manipulates the fields in the dialog box.

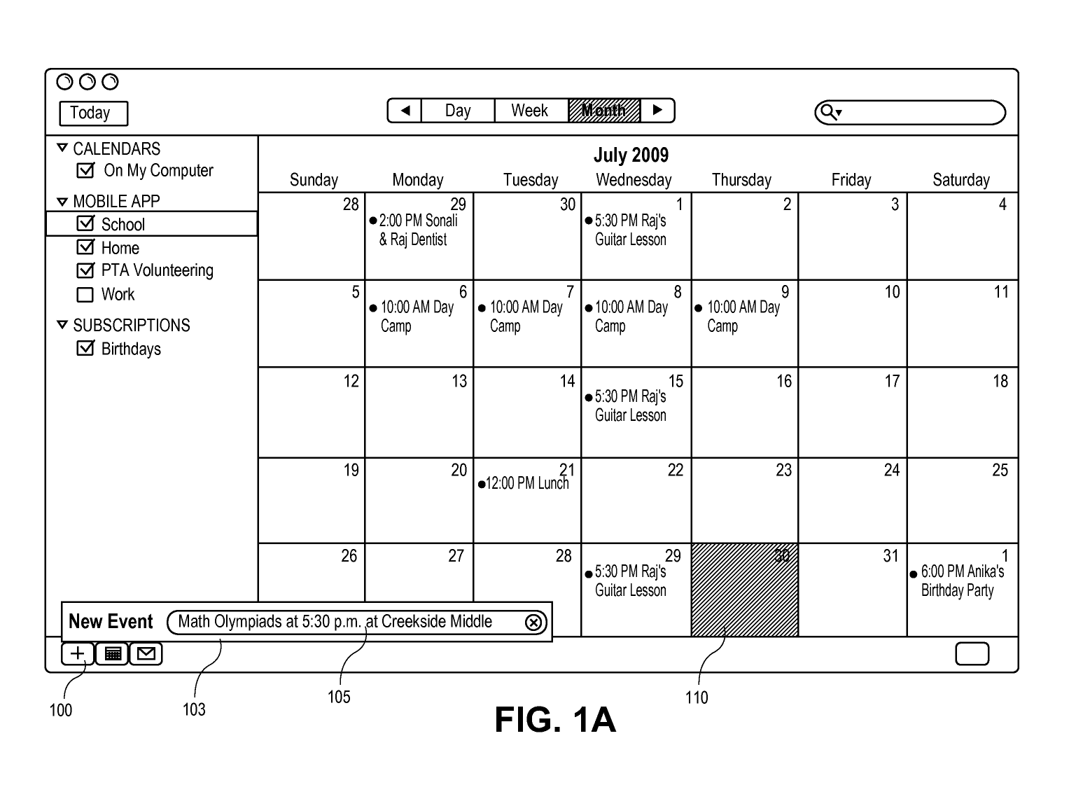

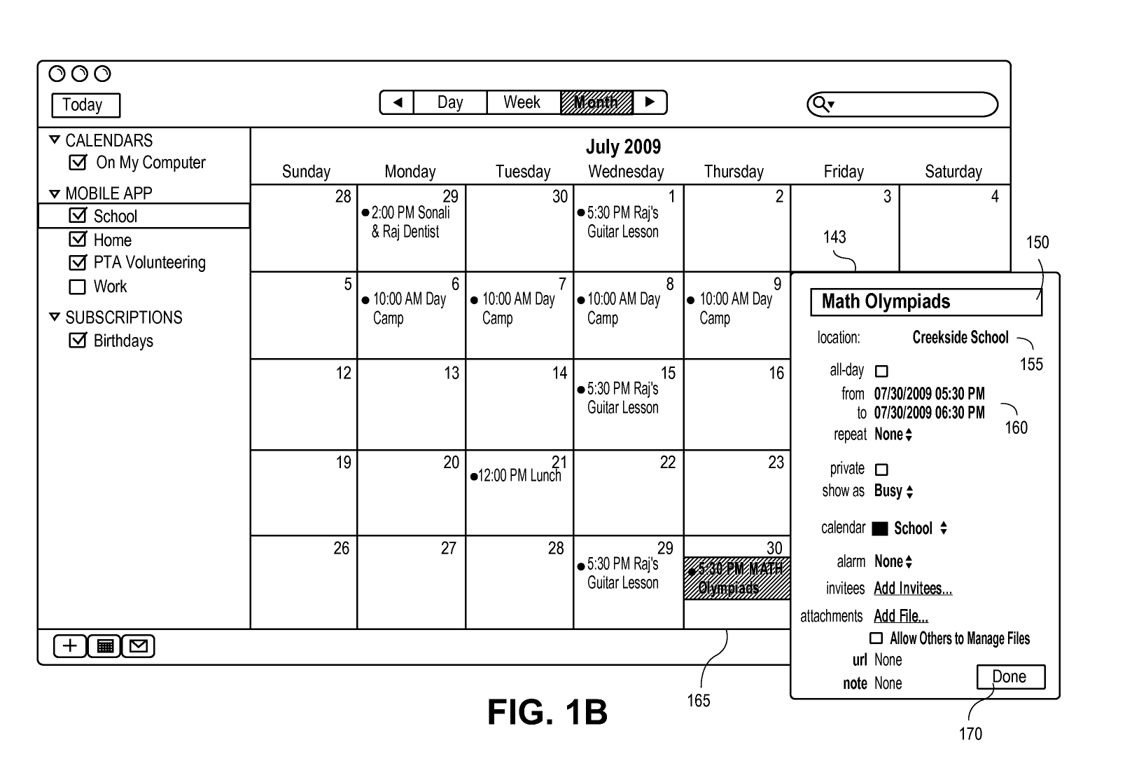

Many events may be more easily and naturally expressed in plain text by the user. For example, FIG. 1A illustrates a manually input calendar event. In the context of FIG. 1A, the user selects day box 110 to indicate that a new calendar event occurs on 30 November. Next, the user clicks on the button 100 to cause the display of text input field 103. This indicates the beginning of a text input session. The user next enters a text input 105 describing the calendar event and presses enter to signal an end of the text input session.

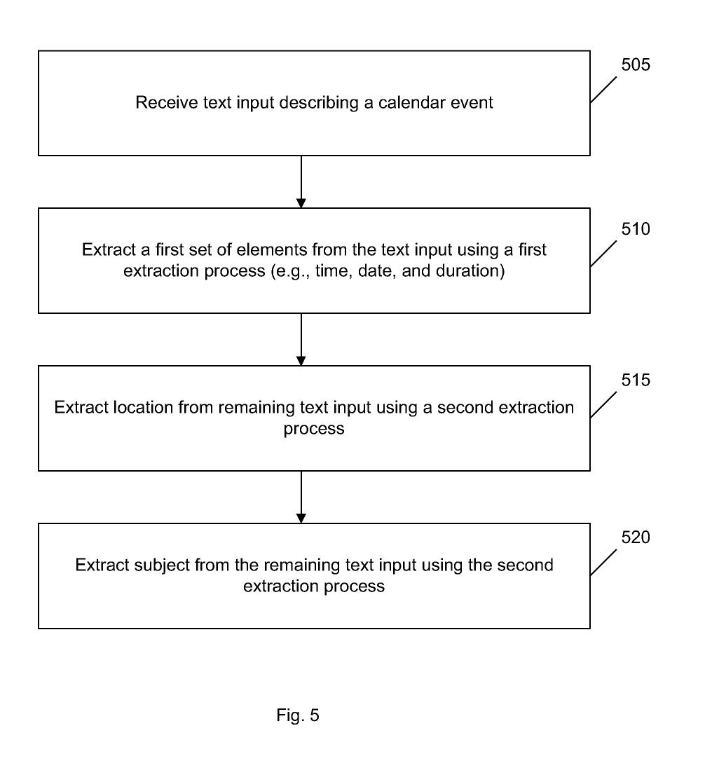

Turning to FIG. 1B, day box 165 corresponds to the state of the user interface after the text input session has been completed. Dialog box 143 is displayed in response to the end of the text input session and includes various elements of the calendar event. The elements are extracted from the text input as described below in conjunction with FIG. 5. Dialog 143 includes subject 150, location 155, date and time 160, and done button 170. The elements of dialog box 143 are added automatically based on the data extracted from the text input. Dialog 143 is displayed to allow the user to confirm the contents of fields 150, 155, 160, etc. When the user is finished, the user clicks on the done button 170 to dismiss the dialog.

In other embodiments, dialog box 143 is not displayed after the text input session is complete. Instead, calendar event 165 is displayed in the calendar based on the original user input and text input. This reduces the cost in time and effort to the user to input the calendar event.

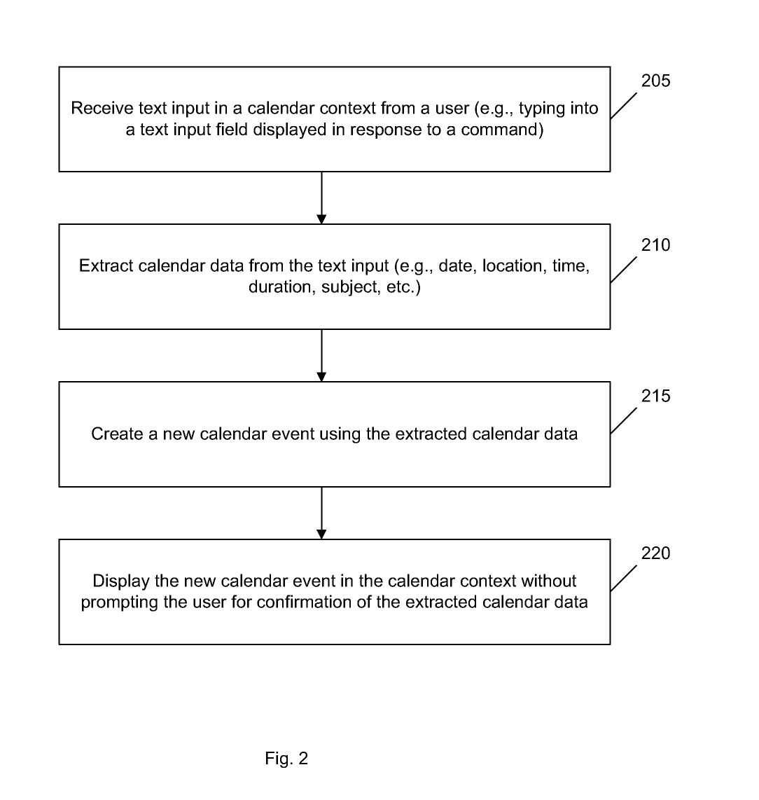

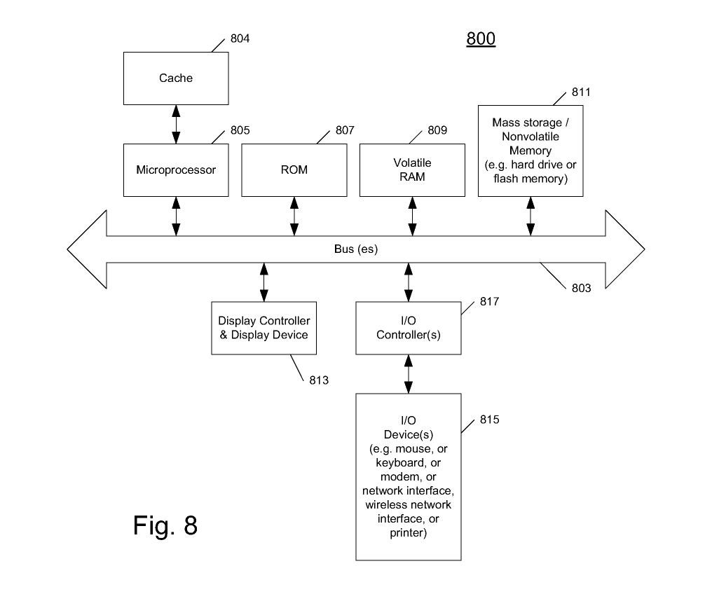

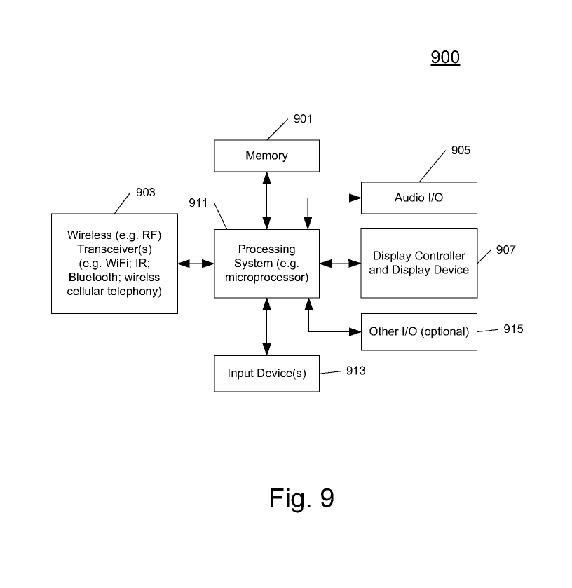

FIG. 2 is a flow chart illustrating a method of automatic event generation, which may be used in conjunction with the data processing system illustrated in FIG. 8 and described below. The method may also be used in conjunction with the device illustrated in FIG. 9 and described below.

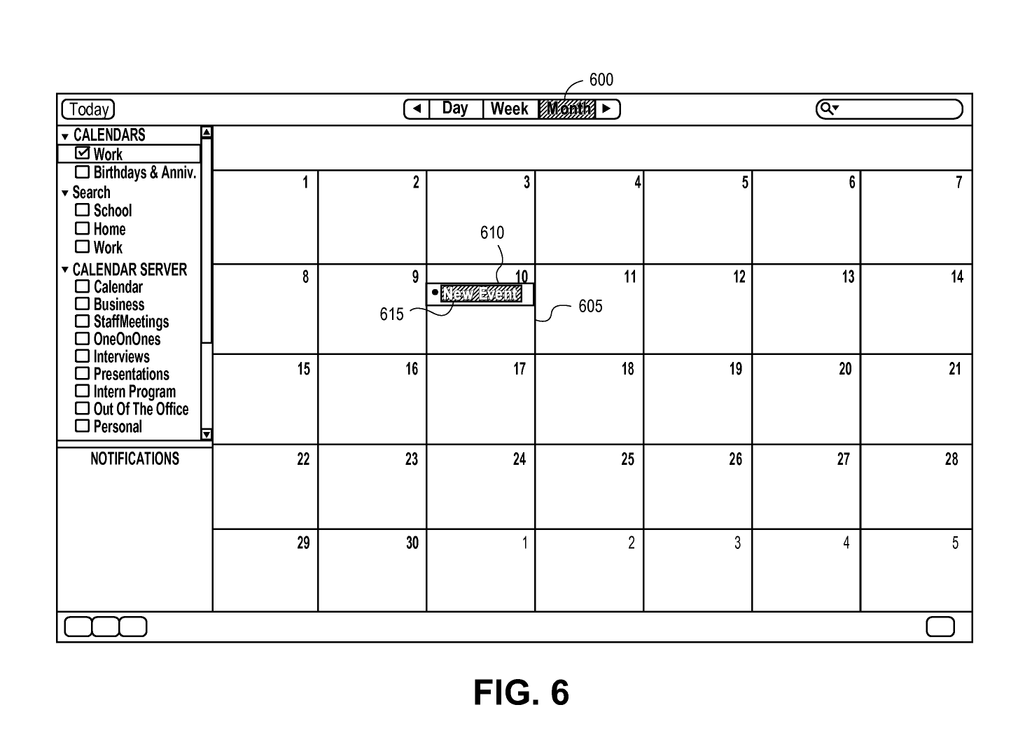

At block 205, the method receives a text input in a calendar context from a user. The text input may be typed by the user using a keyboard or touch interface. The user may select a day box in a month view of a calendar and clicked a button to display a text input field as illustrated in FIG. 1A, or the user may have double-clicked in the day box to generate a text input field in the day box itself, as illustrated in FIG. 6, described below. In other embodiments, only a text input field (such as text input field 103 in FIG. 1A) is displayed, and the user enters the elements of the calendar event in the text input field.

At block 210, the method extracts calendar data from the text input. The text input may include elements such as date, location, time, duration, subject, etc. Calendar data may be extracted in one or more phases, as described below in conjunction with FIG. 5.

At block 215, the method creates a new calendar event using the extracted calendar data. At block 220, the method displays the new calendar event without prompting the user for confirmation of the extracted calendar data. For example, in FIG. 1B, dialog box 143 would not be displayed following creation and display of the new calendar event.

Not confirming the results enhances the risk of an error in the newly created calendar event. However, it enhances the user's efficiency, since the user does not need to review the contents of the dialog box or dismiss the dialog box before continuing to use the calendaring program. The risk of an error is reduced by the calendar application context. Generally, data extraction is performed on textual data originating in different contexts, such as an email program or a voicemail. In these situations, some or all of the text input may be in one or more different contexts other than calendaring.

For example, an email may include a work context, a lunch invitation context, and a joke context, all in the same textual data. This increases the risk of error in the data extraction, since data extraction for calendaring purposes may see similar syntactic patterns in other contexts, but the resulting extraction would be semantically flawed (e.g., mistaking an element in the joke context for an element in the calendar context). This risk is reduced in automatic calendar event generation, since the text input is received from a user in the calendaring context. Since the user is generating the text input with the intention of creating a new calendar event, and the calendar application is performing the extraction assuming the calendar context, the risk that a calendar-like pattern from a non-calendar context will be confused for a calendar pattern is reduced.

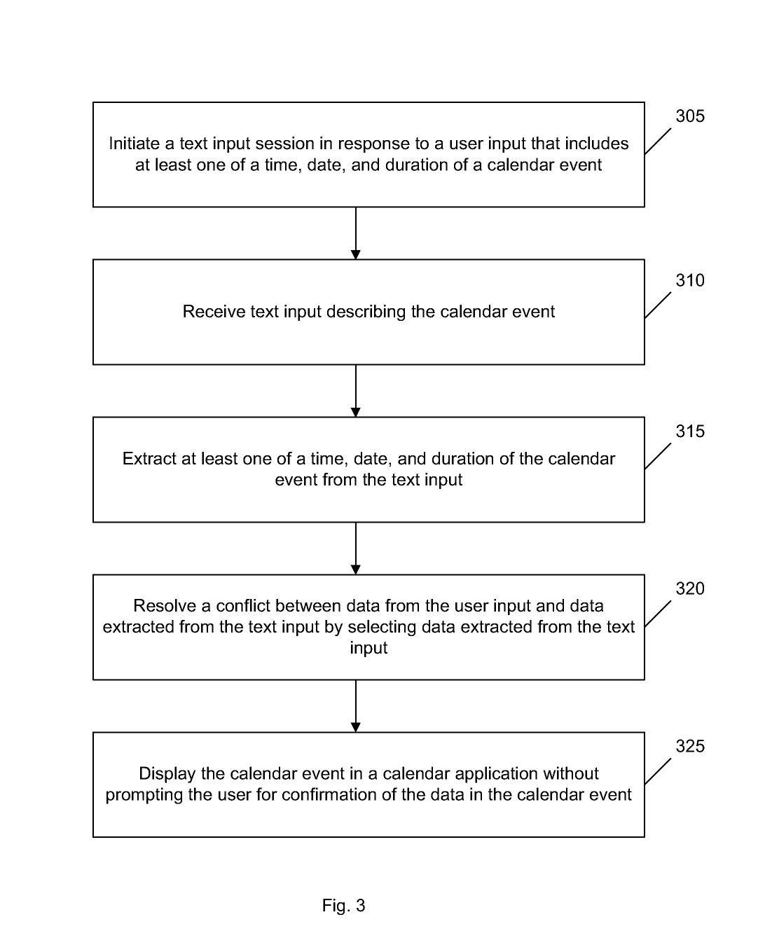

Turning now to FIG. 3, which is a flow chart illustrating a method of resolving a conflict between calendar data from a user input and calendar data from text input. At block 305, the method initiates a text input session in response to a user input that includes at least one of a time, date, and duration of a calendar event. A text input session begins when a start command is received and ends when an end command is received. For example, in FIG. 1A, the start command is the user clicking on the button 100, causing text input field 103 to appear and allowing a user to begin entering a text input. An example of an end command would be the user pressing the “enter” key after the text input has been completed. In the embodiment illustrated in FIGS. 1A-1B, this causes the text input field 103 to disappear and ends the text input session.

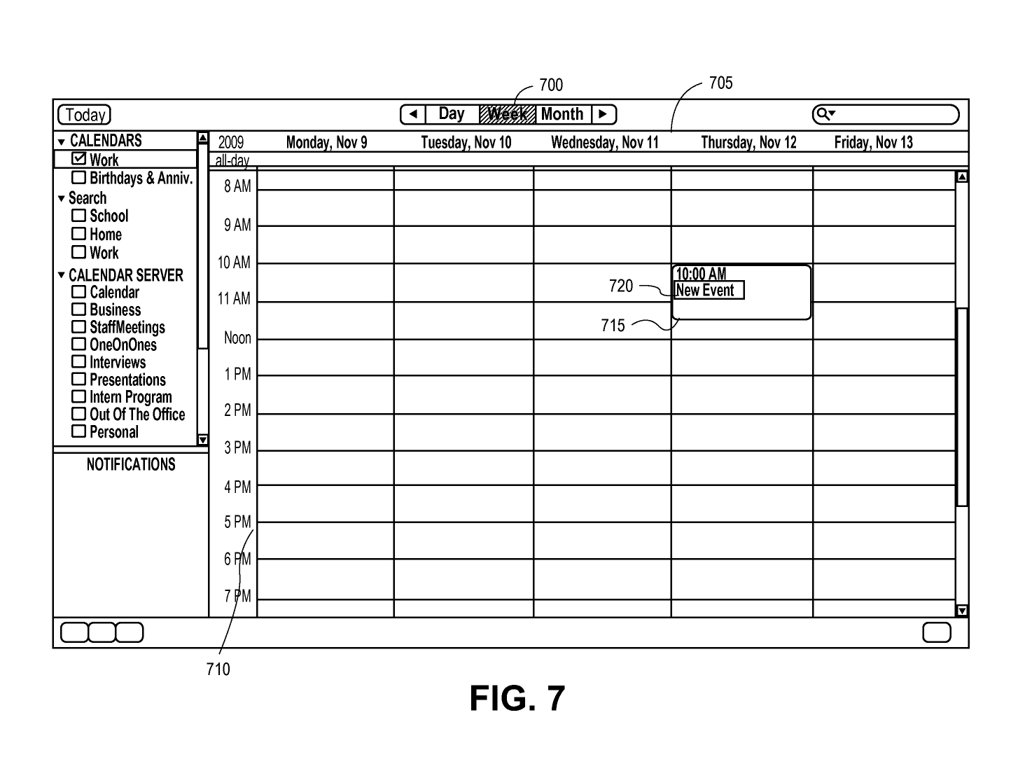

The method at block 305 initiates the text input session in response to the user input that includes at least one of a time, date, and duration of a calendar event. Examples of a user input specifying calendar data are illustrated in FIGS. 6 and 7 and are described in greater detail below. In short, a user input can specify calendar data by being directed to a particular part of a calendar program display. For example, if a user clicks on a portion of a calendar display corresponding to November 8, the user input indicates to create a new calendar event that occurs on that day.

In one embodiment, the user input causes a preliminary calendar event to be displayed in the calendar program. For example, if a user double-clicks on a region of the display corresponding to a particular day, the calendar program may display an unnamed calendar event with a default duration occurring on that day. Event 610 of FIG. 6 illustrates an example of an unnamed calendar event.

At block 310, the method receives a text input describing the calendar event. The text input may have originated from a keyboard coupled to a data processing system performing the method. Alternatively, a different source, such as a touch pad, may have provided the text input.

At block 315, the method extracts at least one of a time, date, and duration of the calendar event from the text input. For example, if the text input were “lunch on November 10th,” the extracted date would be November 10.

At block 320, the method resolves a conflict between data from the user input and data extracted from the text input by selecting data extracted from the text input. For example, if the user input indicated November 8, but the date extracted from the text input was November 10, the method would set the date of the calendar event to November 10 in this embodiment. Resolving conflicts provides an example of how text input in a calendar application context reduces the likelihood of mischaracterized patterns during data extraction. If the text input could have originated from contexts other than calendaring, the date may not be relevant to the calendar event. Since this text input is received from a user using a calendar program to input a calendar event, the likelihood that a date in the text input is wrong is reduced. Different embodiments of the invention utilize different conflict resolution rules to resolve conflicts between user input data and text input data.

At block 325, the method displays the calendar event in the calendar application without prompting the user for confirmation of the data in the calendar event. At block 325, the method displays the calendar event in its completed form, incorporating the elements extracted from text input. As a result of the conflict resolution performed at block 320, the resulting calendar event may need to be displayed on a different part of the calendar application interface. For example, if the unnamed calendar event was created on November 10, and the text input included a date of December 24, displaying the resulting calendar event would require, in this embodiment, changing the display of the calendar program from November to December. In some embodiments, this change may be performed using an animation which provides the user a smooth transition. That is, rather than abruptly re-drawing the calendar program interface to show December, an animation may be displayed in which the new calendar event glides from its original location to its new location, including an animated change of months.

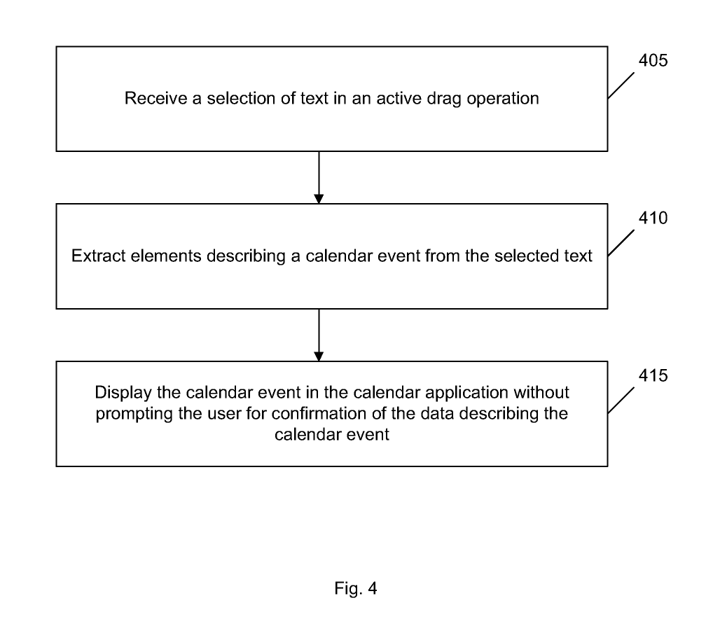

Turning now to FIG. 4, which is a flow chart illustrating a method of automatic event generation from selected text. At block 405, the method receives a block of selected text dragged from a non-calendar application. For example, a user might select a block of text in a word processing application and actively drag that selected text over the calendar program. An active drag generally requires a user input to end. For example, an active drag may occur while the user is moving a mouse with the left mouse button down, and the active drag ends when the user releases the left mouse button. On a touch interface, once initiated, the drag may be active while the user moves one or more fingers across the touch interface, and the active drag may end when the user releases the one or more fingers or takes a different action.

In one embodiment, the user may be required to initiate a text input session in the calendar program before dragging the text over. In another embodiment, when the user drags the selected text over a certain part or any part of a calendar program window, the calendar program automatically initiates a text input session allowing the user to drop the text. Dropping the text in the calendar window may end the text input session as well, or the text input session may remain active allowing the user to add to or modify the dropped text.

At block 410, the method extracts data describing a calendar event from the selected text. At block 415, the method displays a calendar event created from the extracted data without prompting the user for confirmation of the extracted data.

In one embodiment, dragging the text over the calendar application display causes a temporary event to be displayed by the calendar program. For example, if the user hovers the text over a region of the calendar display corresponding to a certain hour on a certain day, the calendar program may display the temporary event with a default duration at the location of the hovering text. The temporary event may be partially transparent while the text is hovering, and become solid if the user releases the text. If elements extracted from the selected text conflict with the elements determined from the hover location, the calendar program may use the extracted elements from the selected text. If the elements determined from the hover location are missing from the selected text (e.g., user hovers over the “10 am” row, but the text input does not include a time), then the missing element can be merged into the temporary event and reflected in its display location.

In another embodiment, dragging selected text over the calendar may cause the calendar to automatically extract elements describing a calendar event from the selected text and display a temporary event corresponding to the elements extracted from the hovering text. This may include a transition animation described above. For example, if the calendar program is currently displaying the month of November, and the elements extracted from the selected text being dragged over the calendar program describe a calendar event occurring in December, the calendar program may animate a transition to the month of December and then display the temporary calendar event at the extracted time and date.

In yet another embodiment, the user drags the selected text over to the calendar program and releases the selected text. In response, the calendar program performs the element extraction, animates a transition to the proper timeframe (if necessary), and then displays the calendar event at the extracted time and date. If certain elements cannot be extracted, such as the time of day, the calendar program may display the event at a default time. In addition, the calendar program may display a visual indication adjacent or within the displayed calendar event indicating to the user that the displayed time is a default time.

Turning now to FIG. 5, which is a flow chart illustrating a method for extracting data from a text input. At block 505, the method receives a text input describing a calendar event. At block 510, the method extracts a time, date, and duration from the text input using a first extraction process. Dialog box 143 of FIG. 1B illustrates extracted time and date 160. The first extraction process may be a system-wide data detection system which is available to the applications running on a data processing system. The first extraction process is context-neutral in that it is designed to operate on text in multiple contexts: on text in an email displayed in an email program, on text in a document displayed in a word processing program, etc. In other embodiments, the set of calendar elements extracted by the first extraction process includes other or additional elements.

At block 515, the method extracts a location of the calendar event from the remaining text using a second extraction process. Dialog box 143 of FIG. 1B illustrates an extracted location 555. The second extraction process may use the same underlying architecture as the first extraction process, except with a different set of assumptions. For example, the second extraction process may assume that it is extracting elements in a calendar context. This would reduce the flexibility of the second extraction process, since it may generate incorrect extractions in non-calendar contexts. However, it would improve the performance of the second extraction process in the calendaring context. As a result, confirmation of elements extracted by the second extraction process may not require confirmation by a user. The second extraction process may exclude the portions of the text input corresponding to the elements extracted at block 510. In another embodiment, the second extraction process may use those portions of the text input to further enhance its own element extraction.

At block 520, the method extracts a subject of the calendar event from the remaining text input using the second extraction process. Subject extraction may be very basic: all elements of the text input not recognized as elements of the calendar event at blocks 510 and 515 become part of the subject. In other embodiments, more analysis is performed. Dialog box 143 of FIG. 1B illustrates an extracted subject 150.

In one embodiment, elements extracted using the first process may conflict with elements extracted using the second process, similarly to conflicts between elements associated with a user input and elements generally extracted from the text input, which are described below in conjunction with FIG. 7. Different embodiments of the invention use different conflict resolution rules to resolve conflicts. In one embodiment, conflicts are resolved by the following descending-order prioritization: 1) elements confirmed by multiple user inputs (e.g., double-click followed by a duration-resize); 2) elements extracted by the calendar-specific extraction process; 3) elements extracted by the context-neutral extraction process; 4) unconfirmed elements from a user input; and 5) default element value. When sets of elements from the various sources described above are merged, elements are dropped or preserved according to these rules. Other embodiments may use other rules. Different default values may be used on a per calendar basis. For example, the default location of events in the work calendar may be a user's office, while the default location of events in the social calendar may be a user's home.

In one embodiment, the second extraction process may extract other types of calendar elements. For example, the second process may extract a recurring element from the text input, such as “every other Tuesday” and include that in the calendar event. The second process might also extract attendees/invitees: “meet with Bob.”

In calendar applications that allow a user to have multiple calendars, the second process might extract a destination calendar for the calendar event. For example, if the user wanted to create a calendar event on his work calendar, the text input might be “work: meet with Bob at 3:30 pm on Tuesday,” causing a new calendar event to be created on the user's work calendar to meet with Bob at 3:30 pm on Tuesday for a default period of time at a default location. The second process may also extract other attributes of calendar events, such as whether the event is private (i.e., hidden from other viewers of the user's calendar); how to reflect the event on the user's calendar (e.g., busy, out of the office, free, etc.); whether the event is an all-day event; whether the event has an alarm associated with it; whether the event has any file attachments; whether the event has a URL associated with it; and any notes regarding the event that aren't part of the subject.

Turning now to FIG. 6, which is a diagram that illustrates a user interface which has received a user input that includes an element of a calendar event. Calendar display 600 is in the month mode, which causes a rectangle or “day box” to be displayed for each day in the selected month. Some or all of the events for a particular day are displayed within the rectangle corresponding to that day. FIG. 6 illustrates receiving a user input in day box 605. The user input (e.g., a double-click) may indicate that the user wants to input text describing a calendar event occurring on that particular day. As a result of the user input, the default subject 615 is highlighted and the user is able to begin typing into text input field 610. In addition to providing the user with the ability to begin entering text input describing a calendar event, the user has communicated a particular date: Nov. 10, 2009. In one scenario, the user double-clicked on November 10 because the event the user is about to describe occurs on November 10. In another scenario, the user double-clicked on November 10 because it was convenient. That is, the date of the event the user will describe in the text input does not occur on November 10. Rather, it was more convenient for the user to have the automatic event generation change the date based on the text input than it was for the user to interact with the user interface to display the correct date in the calendar interface.

For example, if the user wanted to input a calendar event that occurred in February 2012 and the calendar program currently displayed November 2009, it may be easier for the user to rely on the automatic event generation to relocate the calendar event and transition the calendar interface to February 2012. As described in above with respect to the method of conflict resolution, one embodiment of the invention replaces a date associated with the user input with a different date extracted from the text input.

FIG. 7 is a diagram illustrating a user input associated with more than one elements of a calendar event. The calendar display 700 is in the work week mode, so each day of the work week 705 is associated with a column, and rows of the display correspond to times of day 710. A user input has generated an unnamed calendar event 715 on Thursday, November 12, from 10:00 am to 11:30 am. The user is now able to enter a text input replacing default text 720.

In one scenario, the user double-clicked in the November 12 column at the 10 am row because the calendar event to be input occurs at that time, and in response the calendar interface displays an unnamed calendar event. In this scenario, the default duration of an event is 90 minutes. In another scenario, the user randomly clicked on the display because the calendar event the user will describe in the text input is in a different week on calendar. In both these cases, the method of conflict resolution described above would override time and/or date if elements extracted from the text input differed.

However, in a third scenario, the user double-clicks in the November 12 column and at the 10 am row, which creates an unnamed calendar event in the calendar interface. In this scenario, the default duration of an event is 30 minutes, rather than 90 minutes as in the first scenario. The user resizes the displayed calendar event to give it a duration of one and a half hours, overriding the default. By interacting with the default calendar event a second time in the calendar interface, the user confirms that the date and time associated with the user input is correct. In this scenario, an embodiment of the conflict resolution method described above would not override the event elements associated with the user input that created the unnamed calendar event.

In other embodiments, if the user input includes more than one user action and the more than one user action is used to confirm the calendar elements associated with the user input, the second extraction process may be configured to modify its extraction. For example, if the user input confirms an event on November 10, but the text input includes a date of December 4, the second extraction process may include the date “December 4” as part of the subject. The user input might confirm a meeting at 10 am on November 10 for 1 hour, while the text input may be “Meet with Bob in my office to discuss the December 4 release date.” The second extraction process, using the confirmation from the user input, may determine that the subject of the meeting is “Discuss the December 4 release date,” since the confirmed user input has eliminated December 4 as a meeting date. In another embodiment, only the modified duration is considered to be confirmed, and elements extracted from the text input would override the time and date.

FIG. 8 shows one example of a data processing system which may be used with one embodiment the present invention. Note that while FIG. 8 illustrates various components of a computer system, it is not intended to represent any particular architecture or manner of interconnecting the components as such details are not germane to the present invention. It will also be appreciated that network computers, tablet computers, and other data processing systems which have fewer components or perhaps more components may also be used with the present invention.

As shown in FIG. 8, the computer system 800, which is a form of a data processing system, includes a bus 803 which is coupled to a microprocessor(s) 805 and a ROM (Read Only Memory) 807 and volatile RAM 809 and a non-volatile memory 811. The microprocessor 805 is coupled to cache 804. The microprocessor 805 may retrieve the instructions from the memories 807, 809, 811 and execute the instructions to perform operations described above. The bus 803 interconnects these various components together and also interconnects these components 805, 807, 809, and 811 to a display controller and display device 813 and to peripheral devices such as input/output (I/O) devices which may be mice, touch screens, touch pads, touch sensitive input devices, keyboards, modems, network interfaces, printers and other devices which are well known in the art. Typically, the input/output devices 815 are coupled to the system through input/output controllers 817. The volatile RAM (Random Access Memory) 809 is typically implemented as dynamic RAM (DRAM) which requires power continually in order to refresh or maintain the data in the memory.

The mass storage 811 is typically a magnetic hard drive or a magnetic optical drive or an optical drive or a DVD RAM or a flash memory or other types of memory systems which maintain data (e.g., large amounts of data) even after power is removed from the system. Typically, the mass storage 811 will also be a random access memory although this is not required. While FIG. 8 shows that the mass storage 811 is a local device coupled directly to the rest of the components in the data processing system, it will be appreciated that the present invention may utilize a non-volatile memory which is remote from the system, such as a network storage device which is coupled to the data processing system through a network interface such as a modem, an Ethernet interface or a wireless network. The bus 803 may include one or more buses connected to each other through various bridges, controllers and/or adapters as is well known in the art.

FIG. 9 shows an example of another data processing system which may be used with one embodiment of the present invention. The data processing system 900 shown in FIG. 9 includes a processing system 911, which may be one or more microprocessors, or which may be a system on a chip integrated circuit, and the system also includes memory 901 for storing data and programs for execution by the processing system. The system 900 also includes an audio input/output subsystem 905 which may include a microphone and a speaker for, for example, playing back music or providing telephone functionality through the speaker and microphone.

A display controller and display device 907 provide a visual user interface for the user; this digital interface may include a graphical user interface which is similar to that shown on a Macintosh computer when running OS X operating system software. The system 900 also includes one or more wireless transceivers 903 to communicate with another data processing system, such as the system 800 of FIG. 8. A wireless transceiver may be a WiFi transceiver, an infrared transceiver, a Bluetooth transceiver, and/or a wireless cellular telephony transceiver. It will be appreciated that additional components, not shown, may also be part of the system 900 in certain embodiments, and in certain embodiments fewer components than shown in FIG. 9 may also be used in a data processing system.

The data processing system 900 also includes one or more input devices 913 which are provided to allow a user to provide input to the system. These input devices may be a keypad or a keyboard or a touch panel or a multi touch panel. The data processing system 900 also includes an optional input/output device 915 which may be a connector for a dock. It will be appreciated that one or more buses, not shown, may be used to interconnect the various components as is well known in the art. The data processing system shown in FIG. 9 may be a handheld computer or a personal digital assistant (PDA), or a cellular telephone with PDA like functionality, or a handheld computer which includes a cellular telephone, or a media player, such as an iPod, or devices which combine aspects or functions of these devices, such as a media player combined with a PDA and a cellular telephone in one device. In other embodiments, the data processing system 900 may be a network computer or an embedded processing device within another device, or other types of data processing systems which have fewer components or perhaps more components than that shown in FIG. 9.

In the foregoing specification, automatic event generation has been described with reference to specific exemplary embodiments thereof. It will be evident that various modifications may be made thereto without departing from the broader spirit and scope of the invention as set forth in the following claims. The specification and drawings are, accordingly, to be regarded in an illustrative sense rather than a restrictive sense.

What is claimed is:

1. A method comprising:
receiving a text input in a calendar context from a user;
performing a context-neutral extraction process on the text input to generate a first set of elements;
performing, by a data processing system, a calendar-specific extraction process on the text input to generate a second set of elements;
creating a calendar event from the first set of elements and the second set of elements; and
displaying the calendar event on a display device without confirming extracted elements of the calendar event with the user.

2. The method of claim 1, further comprising:
receiving a user input indicating to display a text input field to receive the text input.

3. The method of claim 2, wherein the user input is associated with a third set of elements.

4. The method of claim 3, further comprising:
displaying an initial calendar event using the third set of elements;
determining a conflict between the third set of elements and one of the first set of elements and the second set of elements;
replacing a conflicting element in the third set of elements with a corresponding conflicting element in one of the first set of elements and the second set of elements, wherein the displayed calendar event uses the replacing element.

5. The method of claim 3, wherein the user input comprises at least two separate user actions.

6. The method of claim 5, further comprising:
displaying an initial calendar event using the third set of elements;
determining a conflict between the third set of elements and one of the first set of elements and the second set of elements;
ignoring the conflict.

7. A machine readable storage medium storing executable instructions which when executed by a processor cause the processor to perform operations, the operations comprising:
displaying a calendar interface on a display device;
receiving an indication that an active drag operation of a selection of text is located over the calendar interface;
extracting a first set of elements from the selection of text;
generating a calendar event using the first set of elements;
displaying the calendar event in a temporary state in the calendar interface while the active drag operation is over the calendar interface, wherein the displayed calendar interface is updated to reflect the first set of elements.

8. The machine readable storage medium of claim 7, further comprising:
receiving an indication that the active drag operation has ended while located over the calendar interface;
displaying the calendar event in a permanent state in the calendar interface in response to the indication.

9. The machine readable storage medium of claim 7, wherein the indication further comprises a particular location within the calendar interface that the active drag operation is located.

10. The machine readable storage medium of claim 9, further comprising:
determining, based on the particular location, a second set of elements;
determining that a first element of the second set of elements is not present in the first set of elements;
merging the first element into the first set of elements, wherein display of the temporary event reflects the first element.

11. The machine readable storage medium of claim 9, wherein displaying the calendar event in a temporary state includes increasing the transparency of the displayed event.

12. The machine readable storage medium of claim 7, wherein updating the displayed calendar interface comprises an animated transition from an initial time frame to a new time frame indicated by the calendar event.

13. A method comprising:
receiving a user input including a first set of elements;
displaying a text input field in response to the user input receiving a text input from the text input field;
extracting a second set of elements from the text input using at least one extraction process;
merging the first set of elements with the second set of elements according to a conflict resolution rule;
displaying a calendar event created from the merged elements on a display device in a calendar application, wherein the calendar event is displayed without user confirmation of the merged elements.

14. The method of claim 13, wherein the first set of elements comprises one or more of the following: a start time, an end time, a day of the week, a date, and a duration.

14. The method of claim 13, wherein the first set of elements corresponds to a region on a display of the calendar application.

15. The method of claim 14, wherein the text input field is displayed within the region.

16. The method of claim 14, wherein the text input field is displayed near an edge of the display of the calendar application.

17. The method of claim 13, wherein the at least one extraction process comprises a context-neutral extraction process and a calendar-specific extraction process.

18. The method of claim 13, wherein the conflict resolution rule comprises a list of elements prioritized according to source.

19. A data processing system comprising:
means for receiving a first set of elements and a second set of elements;
means for merging the first of elements and the second set of elements according to a conflict resolution rule, wherein the first set of elements is associated with a user input to a calendar interface means and the second set of elements is extracted from a text input using at least one extracting means;
means for displaying, on a hardware display device, a calendar event generated using the merged elements, wherein the calendar event is displayed without user confirmation of the merged elements.

20. The data processing system of claim 19, wherein the first set of elements comprises at least one of the following: start time, end time, date, duration, and day of the week.

21. The data processing system of claim 19, wherein the merged elements comprise at least one of the following: a subject, a location, a calendar selection, an alarm, a status, a URL, and a note.
